(19) United States
(12) Patent Application Publication
(10) Pub. No.: US 2009/0314577 A1
(43) Pub. Date: Dec. 24, 2009

(54) HARNESS WITH SUPPORTING BINDING

(75) Inventor: Kai Rinklake, Neuwied (DE)

Correspondence Address: LAW OFFICE OF DELIO & PETERSON, LLC., 121 WHITNEY AVENUE, 3RD FLLOR, NEW HAVEN, CT, 06510, US

(73) Assignee: SKYLOTEC GmbH, Neuwied (DE)

(21) Appl. No.: 12/307,085

(22) PCT Filed: Jul. 9, 2007
(86) PCT No.: PCT/EP07/06061

§ 371 Date: Dec. 30, 2008

(30) Foreign Application Priority Data
Jul. 11, 2006 (DE) 20 2006 010 717.7

(51) Int. Cl. A62B 35/00

(52) U.S. Cl. 182/3

(57) ABSTRACT

The invention relates to a harness for personal safety, in particular a safety harness, with two shoulder pieces (10) and two leg pieces (12), wherein the shoulder pieces (10) are connected to each other to form a cross shaped piece (14) at one end, and the other ends are respectively connected to the leg pieces (12), and the leg pieces (12) are further connected to the cross-shaped piece (14). In this way, the shoulder pieces (10), leg pieces (12), and cross-shaped piece (14) are each bound with at least one binding (18), and the bindings (18) of the shoulder pieces (10), leg pieces (12), and the cross-shaped piece (14) are connected to each other in such a way that the bindings (18) form the load-bearing elements of the harness.

The present invention relates to a harness for personal protection, in particular a safety harness, with two shoulder parts and two leg parts, the shoulder parts being connected to each other at one end to form a crosspiece and having the respective other ends connected to the leg parts, and the leg parts being furthermore connected to the crosspiece, in accordance with the preamble of claim 1.

EP 1 326 682 B1 discloses a protective harness with a lumbar part and two leg parts, in which the lumbar part is composed of a padding and of bindings that bound the padding and at the same time form the load-bearing elements of the harness.

The object of the invention is to improve a harness of the abovementioned type in terms of production costs and wearing comfort. At the same time, the harness is intended to securely hold the body of a user and make it impossible to fall out of the harness, such that the harness can also be used as a safety harness.

According to the invention, this object is achieved by a harness of the abovementioned type having the features characterized in claim 1. Advantageous embodiments of the invention are described in the other claims.

According to the invention, in a harness of the abovementioned type, shoulder parts, leg parts and crosspiece are each bounded by at least one binding, and the bindings of the shoulder parts, leg parts and the crosspiece are connected to each other in such a way that the bindings form the load-bearing elements of the harness.

This has the advantage that shoulder part, leg part and crosspiece can be made from a fabric that is optimized for good wearing comfort and low production costs, without having to take account of its load-bearing capacity and strength. In other words, the shoulder parts, leg parts and crosspiece do not necessarily have to be designed as expensive straps since they have no load-bearing function.

In a preferred embodiment with particularly good properties in terms of wearing comfort, the shoulder parts, leg parts and/or crosspiece are made at least partially from an air-permeable fabric, and the air-permeable fabric is bounded by the bindings.

For example, shoulder part, leg part and crosspiece are together formed in one piece from a bounded section of fabric.

An additional attachment point in the chest area of a person using the harness is obtained by virtue of the fact that a chest strap eyelet is formed on each shoulder part, each chest strap eyelet being bounded by at least one binding, which is connected to the bindings of the shoulder parts in such a way that the bindings of the chest strap eyelets form load-bearing elements.

The chest strap eyelets are preferably made from an air-permeable fabric, and the air-permeable fabric is bounded by the bindings.

In a preferred development of the invention, an attachment element, in particular a D-ring or a strap loop, is arranged on the crosspiece and is connected to the harness via at least two straps.

A secure and force-transmitting connection between the attachment element and the load-bearing elements of the harness is provided by virtue of the fact that each strap extends with the respective ends into the bounded edge of the crosspiece with the binding.

In a preferred embodiment of the invention, a lumbar part is additionally provided, the lumbar part being bounded by at least one binding, which is connected to the bindings of the harness in such a way that the binding of the lumbar part forms a load-bearing element.

For example, the shoulder parts and the crosspiece are together cut in the shape of a vest.

Further fastening points, for example for tools and/or as attachment point for a rope, are obtained by virtue of the fact that at least one fastening element is secured with at least one strap on the harness at a distance from the bindings, the strap extending with each of its ends into the bounded edge with the binding.

The invention is explained in more detail below with reference to the drawing, in which:

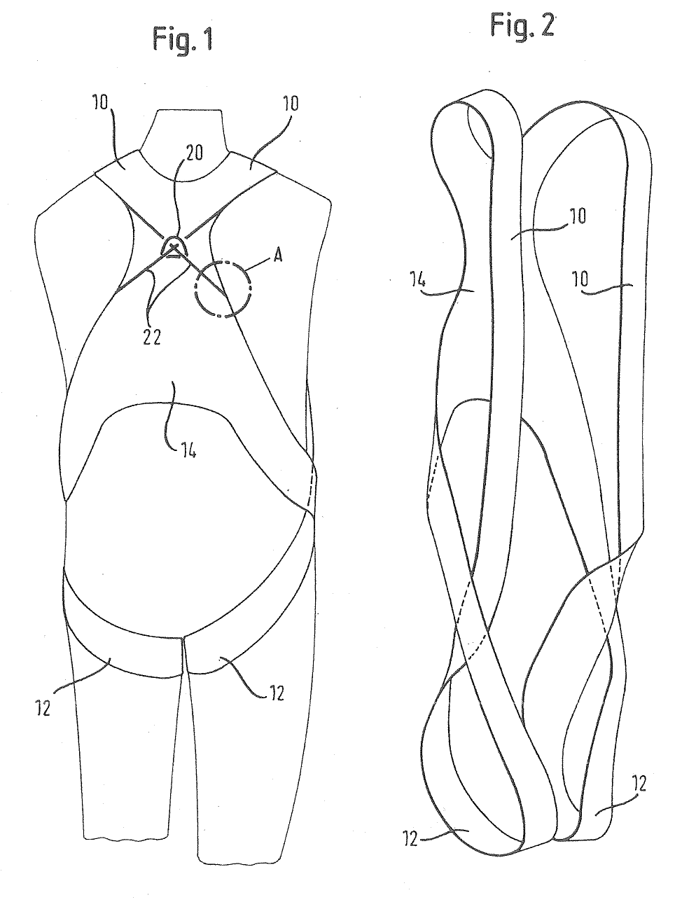

FIG. 1 shows a perspective view of a preferred embodiment of a harness according to the invention,

FIG. 2 shows another perspective view of the harness from FIG. 1,

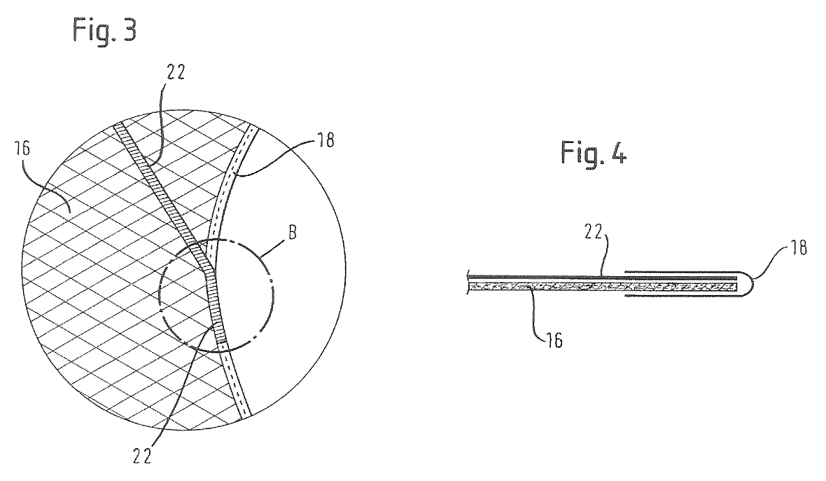

FIG. 3 shows an enlarged view of the detail A from FIG. 1,

FIG. 4 shows an enlarged sectional view of the detail B from FIG. 3, and

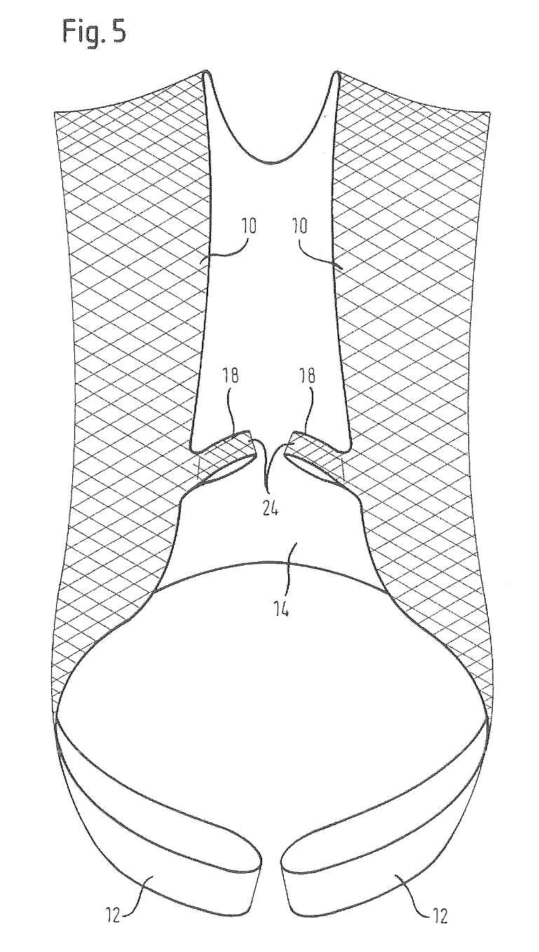

FIG. 5 shows a perspective view of an alternative embodiment of a harness according to the invention.

The preferred embodiment of a harness according to the invention shown in FIGS. 1 and 2 comprises two shoulder parts 10 and two leg parts 12. The shoulder parts 10 are connected to each other at one end to form a crosspiece 14 and have the respective other ends each connected to a leg part 12. The leg parts 12 are furthermore connected to the crosspiece 14. In the embodiment shown, shoulder parts 10, leg parts 12 and crosspiece 14 are together formed in one piece from a bounded section of fabric.

As can be seen from FIGS. 3 and 4, shoulder parts 10, leg parts 12 and crosspiece 14 are each made from an open-meshed fabric 16 and bounded by a binding 18. The bindings 18 of shoulder parts 10, leg parts 12 and crosspiece 14 are connected to one another in such a way that the bindings 18 form the load-bearing elements of the harness.

A D-ring 20, which is connected to the harness via straps 22, is arranged in the area of the crosspiece 14. Here, the straps 22 extend with their respective ends into the bounded edge of the crosspiece 14 with the binding 18 (FIG. 4).

In the second preferred embodiment of a harness according to the invention shown in FIG. 5, parts having the same function are designated by the same reference numbers as in FIGS. 1 through 4, and reference is therefore made to the above description of FIGS. 1 through 4. In this alternative embodiment, shoulder parts 10 and crosspiece 14 are cut together as a vest. In addition, chest strap eyelets 24 are formed on the shoulder parts 10, each chest strap eyelet 24 being bounded by at least one binding 18, which is connected to the bindings 18 of the respective shoulder part 10 in such a way that the bindings 18 of the chest strap eyelets 24 form load-bearing elements. The vest composed of shoulder parts 10 and crosspiece 14 is itself made from an air-permeable fabric.

1-10. (canceled)

11. A safety harness for personal protection comprising two shoulder parts and two leg parts, the shoulder parts being connected to each other at one end to form a crosspiece and having the respective other ends connected to the leg parts, and the leg parts being connected to the crosspiece, including having the shoulder parts, leg parts and crosspiece each bound by at least one binding, and the bindings of the shoulder parts, leg parts and crosspiece connected to each other in such a way that the bindings form the load-bearing elements of the harness.

12. The harness of claim 11 including having the shoulder part, leg part or crosspiece made at least partially from an air-permeable fabric, and the air-permeable fabric bounded by the bindings.

13. The harness of claim 11 including having the shoulder part, leg part and crosspiece together formed in one piece from a bounded section of fabric.

14. The harness of claim 11 including a chest strap eyelet formed on each of the shoulder parts, each chest strap eyelet being bounded by at least one binding, which is connected to the bindings of the shoulder parts in such a way that the bindings of the chest strap eyelets form load-bearing elements.

15. The harness of claim 13 including a chest strap eyelet formed on each of the shoulder parts, each chest strap eyelet being bounded by at least one binding, which is connected to the bindings of the shoulder parts in such a way that the bindings of the chest strap eyelets form load-bearing elements.

16. The harness of claim 14 including having the chest strap eyelets made from an air-permeable fabric, and the air-permeable fabric bounded by the bindings.

17. The harness of claim 11 including an attachment element arranged on the crosspiece and connected to the harness via at least two straps.

18. The harness of claim 17 wherein the attachment element includes a D-ring or a strap loop.

19. The harness of claim 17 wherein each strap extends with the respective ends into the bounded edge of the crosspiece with the binding.

20. The harness of claim 11 further comprising a lumbar part, the lumbar part being bounded by at least one binding, which is connected to the bindings of the harness in such a way that the binding of the lumbar part forms a load-bearing element.

21. The harness of claim 13 further comprising a lumbar part, the lumbar part being bounded by at least one binding, which is connected to the bindings of the harness in such a way that the binding of the lumbar part forms a load-bearing element.

22. The harness of claim 11 including having the shoulder parts and the crosspiece cut in the shape of a vest.

23. The harness of claim 13 including having the shoulder parts and the crosspiece cut in the shape of a vest.

24. The harness of claim 11 wherein the crosspiece includes at least one fastening element secured with at least one strap on the harness at a distance from the bindings, the strap extending with each of its ends into the bounded edge with the binding.

25. The harness of claim 13 wherein the crosspiece includes at least one fastening element secured with at least one strap on the harness at a distance from the bindings, the strap extending with each of its ends into the bounded edge with the binding.
